(19) United States
(12) Patent Application Publication
(10) Pub. No.: US 2008/0006343 A1
(43) Pub. Date: Jan. 10, 2008

(54) Electric trim saw

(76) Inventor: Justin Carl Bennett, Layton, UT (US)

Correspondence Address: JUSTIN CARL BENNETT, 1171 S. WESTSIDE DRIVE, LAYTON, UT, 84041, US

(21) Appl. No.: 11/324,523

(22) Filed: Jan. 4, 2006

(51) Int. Cl. B27C 5/04

(52) U.S. Cl. 144/137; 144/143; 144/144.51; 144/3.1

(57) ABSTRACT

The electric trim saw is unique because of the way it cuts. The electric motor is mounted on a two way slide, the slides allow the saw to follow the exact contour of any piece of trim (Baseboard, Chair rail Etc.) the guide tip has a fine point with a tiny ball bearing kind of like a ball point pen. This tip is on the same plane as the cutting bit therefore the bit cuts the board on the base plate with the exact same contour as the scrap piece in the clamp. The clamp holds the scrap piece in line and in place while the cuts are being made.

The Electric Trim Saw was designed for the construction trade. Specifically for carpenters, general contractors or others who work with any kind of moldings such as base boards, door casing, chair rail, crown mold, etc.

Fine craftsman have always used hand coping saws to cope trim in and around corners to make it fit tight against another of the same style trim. There are many uses for the coping saw and it does a good job but it is very time consuming to hand cut each piece of trim especially on large jobs. That's why a lot of carpenters will just use an electric miter saw and cut the two pieces on an angle such as two 45 degree angles to make a 90 degree angle. This way is much faster but the joint does not turn out as good as with the coping method.

The Electric Trim Saw is an electric motor driven saw which has a thin high speed spinning wood cutting bit (kind of like a small router) that is mounted on a overhead slide that allows you to pull the bit toward you and at the same time horizontal bearings let it move left and right. There is a scribe point mounted at the exact same point as the cutting bit. The scribe follows a small piece (approximately one inch) of whatever trim design you are cutting which is mounted in a vise on the right side of the saw. The trim piece can be cut off of any size or shape of trim up to 8″ wide. With the trim piece in the vise you can adjust the vise left or right to accommodate different thickness of trim. The trim piece will always be facing the same direction as the length you are cutting. Both pieces can be reversed to cut the other side if necessary. However most of the time you only cope one end of each board and go in one direction around the room.

Using this tool is very easy you just turn it on and pull it towards you, as you pull springs located on the left side of the horizontal bearings keep the scribe tight against the scrap piece in the vise and it follows all of the curves in the trim cutting the same design into your workable board, then all you have to do is measure the length you need and cut the other end straight and repeat all of the way around the room.

This tool gives your work the same quality finished joint as the hand coping saw and the speed of the power miter saw. I have used this tool on several jobs and have found it to be very useful. It has cut man hours almost in half and gives you a perfect fit every time.

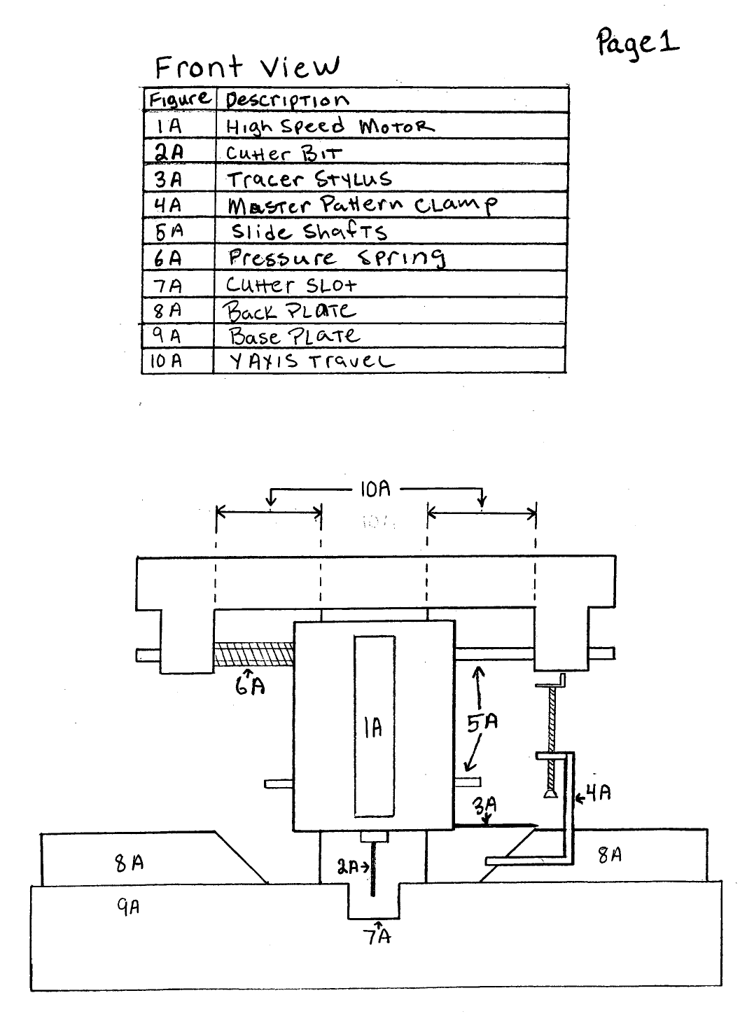

FIG. 1 A: The slides let the saw move fluidly back and forth for cutting through any width of trim up to 8″.

FIG. 2 A: The clamp holds the scrap piece of trim above the board you are cutting for the guide to follow.

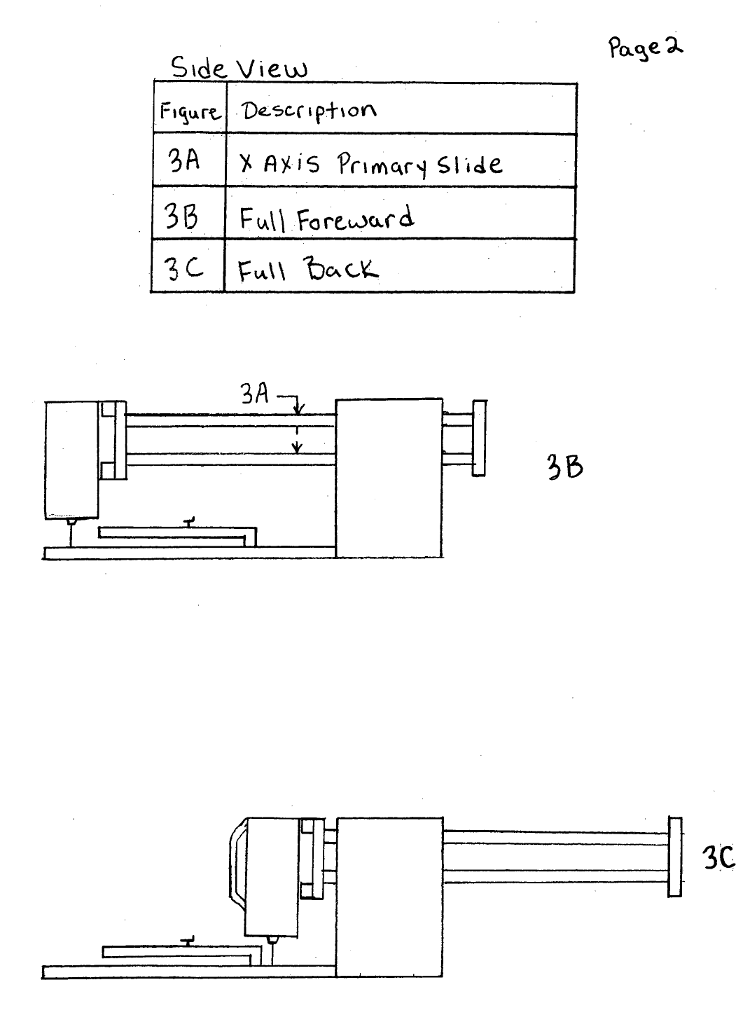

FIG. 3 A: The horizontal slide bearings let the motorized saw move left and right to follow the curves in the trim held by the clamp.

FIG. 4 A: The slide spring holds the guide tight against the trim piece in the clamp.

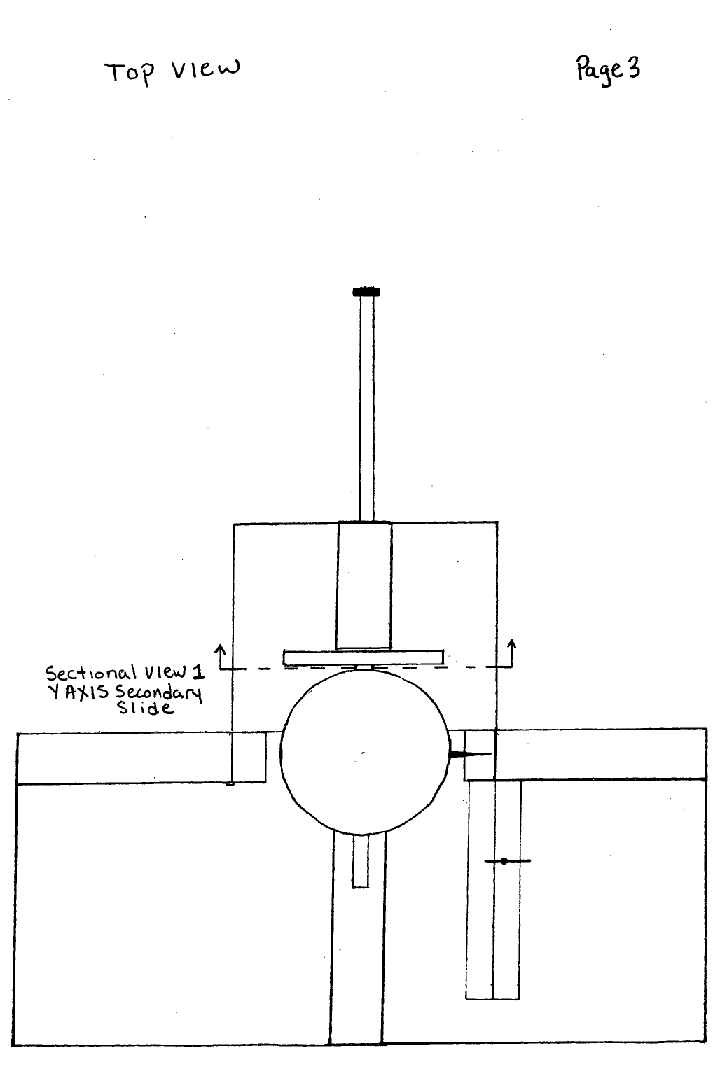

FIG. 5 A: The guide tip is in line with the cutting bit and follows the curves in the trim piece held by the clamp.

FIG. 6 A: The cutting slot is a notch in the base plate where the trim that is being cut sits, this lets the bit cut through the trim with out hitting the base plate.

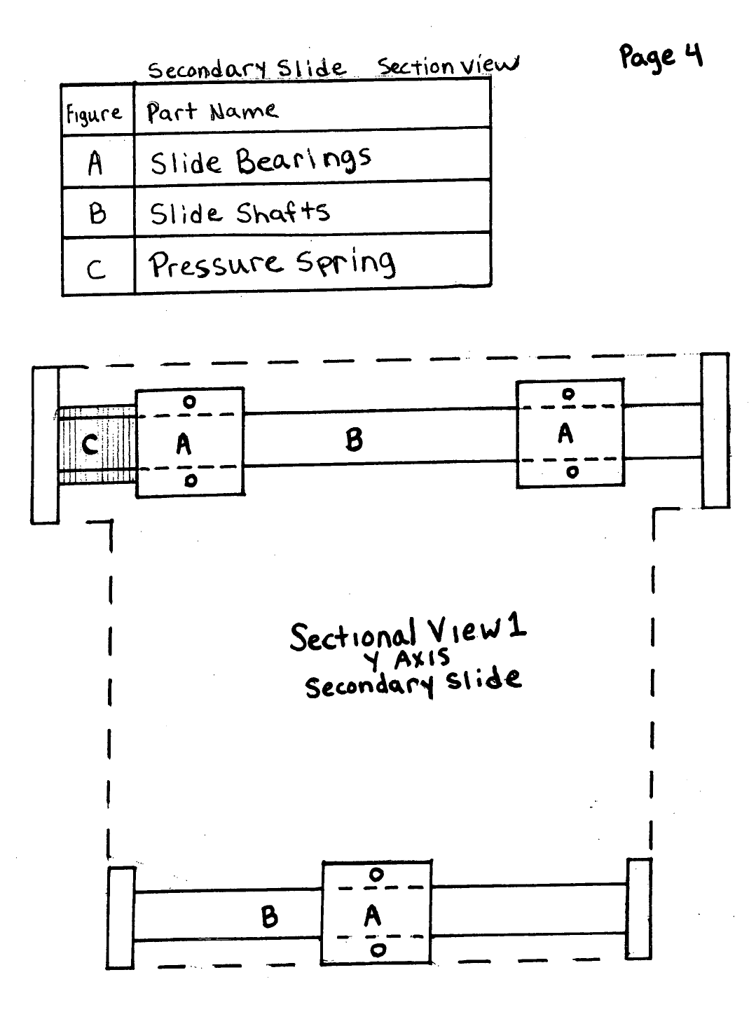

FIG. 7 A: The base plate is where the trim being cut sits.

FIG. 8 A: The back plate is at a 90 degree angle and sits on top of the base plate the trim being cut is pushed tight against the back plate to keep it straight on the base plate.

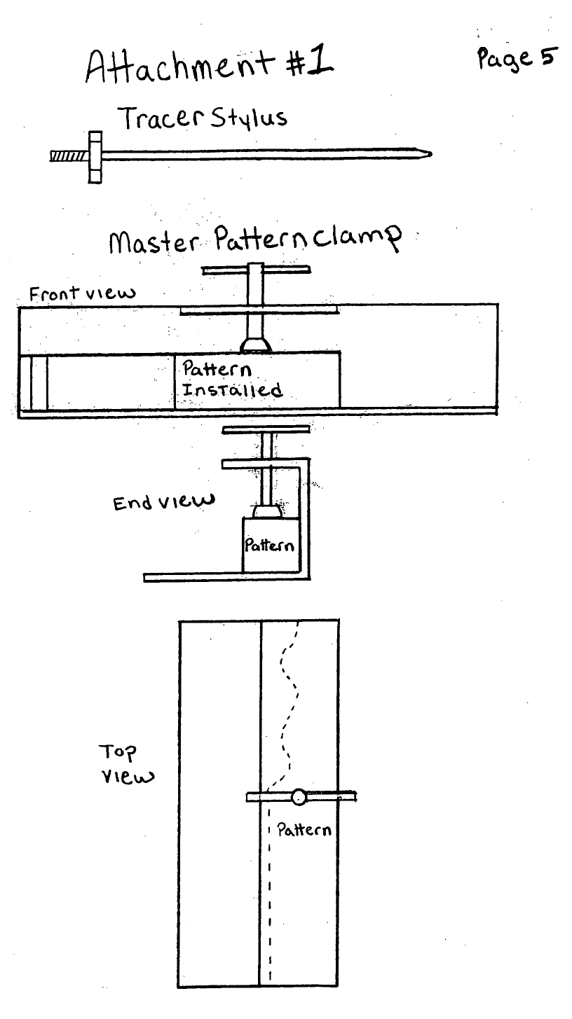

FIG. 9 A: The slide rods are through the slide bearings and let the bearings move freely back and forth or left to right.

FIG. 10 A: The electric motor or small router is mounted on the slides and has a thin wood cutting bit in the bottom. The motor is adjustable up and down to accommodate different thickness of trim.

1: The two way slide (FIGS. 1A and 9A) lets the saw move both back and forth and left to right.

2: The guide tip (FIG. 5A) has a sharp point with a tiny ball bearing that allows it to follow any contour in the trim you are cutting. It also follows the exact line as the cutting bit.

3: The clamp (FIG. 2A) is above the base plate or cutting area and holds the scrap piece secure for the guide tip to follow.
